(19) United States
(12) Patent Application Publication
(10) Pub. No.: US 2015/0166770 A1
(43) Pub. Date: Jun. 18, 2015

(54) ENHANCED FLAME RETARDANT ARTICLES

(71) Applicant: E I DU PONT DE NEMOURS AND COMPANY, Wilmington, DE (US)

(72) Inventors: LAKSHMI KRISHNAMURTHY, WILMINGTON, DE (US); BRIAN D. MATHER, NEWARK, DE (US); MARK GARY WEINBERG, WILMINGTON, DE (US)

(21) Appl. No.: 14/561,454

(22) Filed: Dec. 5, 2014

Related U.S. Application Data
(60) Provisional application No. 61/917,456, filed on Dec. 18, 2013.

(51) Int. Cl. C08K 5/527; C08K 5/07; C08K 5/526

(52) U.S. Cl. CPC C08K 5/527; C08K 5/526; C08K 5/07

(57) ABSTRACT

The present invention is directed toward a flame retardant article comprising a polyolefin, an activatable flame retardant and an optional flame retardant activator wherein the flame retardant performance of the flame retardant article is at least about 1% higher on the limiting oxygen index (LOI) scale after activation treatment than before activation treatment as measured by LOI ASTM D2863. The flame retardant article can be made into a building substrate, garment, banner, light reflector and cover.

This application claims the benefit of priority of U.S. Provisional Application No. 61/917,456 filed Dec. 18, 2013, all of which is incorporated herein by reference in it's entirety.

### TECHNICAL FIELD

This invention relates to enhanced flame retardant articles. In particular, this invention further relates to enhanced flame retardant polyolefin fibers and sheet structures therefrom. These sheet structures can be used in, for example, a flame retardant building substrate, garment, banner, light reflector and cover.

### BACKGROUND

Polyolefin fibers, e.g., polyethylene and polypropylene fibers are high volume/low cost synthetics that are remarkable for their stain and abrasion resistance. As with all plastics, certain uses have required that the flammability of the polymer be reduced. When decreased flammability has been required, it has generally not been provided by the polyolefin fiber itself, but has instead been provided by one of the other components in the fabricated article.

Polyolefin fibers can be made into a sheet which has been used in many end uses, for example, a building substrate, garment, banner, light reflector and cover.

Although flame retardant coatings have been used, a flame retardant that can be spun directly into the fiber would offer advantages in durability and potentially cost.

It would be desirable to make a sheet made from a flame retardant polyolefin fiber that does not suffer from the aforementioned disadvantages.

### SUMMARY

The present invention is directed toward a flame retardant article comprising: (a) from about 50 weight percent to less than about 100 weight percent of a polyolefin; (b) up to about 15 weight percent of an activatable flame retardant; and (c) from 0 weight percent to about 5 weight percent of a flame retardant activator; and wherein the flame retardant performance of the flame retardant article is at least about 1% higher on the limiting oxygen index (LOI) scale after activation treatment than before activation treatment as measured by LOI ASTM D2863.

### DETAILED DESCRIPTION

### Definition of Terms

The term “flame retardant article” as used herein is intended to include materials that have some resistance to flame propagation.

The term “activatable flame retardant” as used herein, is intended to include materials that have a capability to increase flame retardancy when triggered by an activation treatment.

The term “flame retardant activator” as used herein is intended to include materials that act upon the activatable flame retardant to increase flame retardancy when triggered by an activation treatment.

The term “activation treatment” as used herein is intended to mean any method which increases flame retardancy of the activatable flame retardant.

The term “polymer” as used herein generally includes but is not limited to, homopolymers, copolymers (such as for example, block, graft, random and alternating copolymers), terpolymers, etc., and blends and modifications thereof. Furthermore, unless otherwise specifically limited, the term “polymer” shall include all possible tacticities of the material. These configurations include, but are not limited to isotactic, syndiotactic, and atactic tacticities. The term “polymer” also includes all topologies such as long chain branching, short chain branching, crosslinked networks and linear polymers.

The term “polyolefin” as used herein is intended to mean any of a series of largely saturated polymeric hydrocarbons composed only of carbon and hydrogen. Typical polyolefins include, but are not limited to, polyethylene, polypropylene, polymethylpentene, and various combinations of the monomers ethylene, propylene, and methylpentene.

The term “polyethylene” as used herein is intended to encompass not only homopolymers of ethylene, but also copolymers wherein at least 85% of the recurring units are ethylene units such as copolymers of ethylene and alpha-olefins. Preferred polyethylenes include low-density polyethylene, linear low-density polyethylene, and linear high-density polyethylene (HDPE). A preferred linear high-density polyethylene has an upper limit melting range of about 130° C. to 140° C., a density in the range of about 0.941 to 0.980 gram per cubic centimeter, and a melt index (as defined by ASTM D-1238-57T Condition E) of between 0.1 and 100, and preferably less than 4.

The term “polypropylene” as used herein is intended to embrace not only homopolymers of propylene but also copolymers where at least 85% of the recurring units are propylene units. Preferred polypropylene polymers include isotactic polypropylene and syndiotactic polypropylene.

The term “plexifilament” as used herein means a three-dimensional integral network or web of a multitude of thin, ribbon-like, film-fibril elements of random length and with a mean film thickness of less than about 4 microns and a median fibril width of less than about 25 microns. In plexifilamentary structures, the film-fibril elements intermittently unite and separate at irregular intervals in various places throughout the length, width and thickness of the structure to form a continuous three-dimensional network.

### DESCRIPTION

The present invention is directed toward a flame retardant article comprising: (a) from about 50 weight percent to less than about 100 weight percent of a polyolefin; (b) up to about 15 weight percent of an activatable flame retardant; and (c) from 0 weight percent to about 5 weight percent of a flame retardant activator; and wherein the flame retardant performance of the flame retardant article is at least about 1% higher on the limiting oxygen index (LOI) scale after activation treatment than before activation treatment as measured by LOI ASTM D2863. Surprisingly, it has been discovered that certain flame retardants can exhibit higher flame retardancy after activation with an activation treatment.

Typical polyolefin polymers used for the flame retardant article are selected from the group consisting of polyethylene, polypropylene and their copolymers.

Suitable activatable flame retardants contain phosphorous. General types of phosphorous containing activatable flame retardants are selected from the group consisting of: phosphate esters, phosphonate esters, phosphite esters, and mixtures thereof. More specific types of phosphorus containing activatable flame retardant are selected from the group consisting of:

(a) a resorcinol bis(diphenyl phosphate) of the general formula (1):

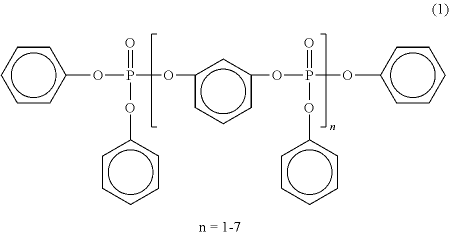

wherein n has an average value of from about 1 to about 7;

(b) a bis-phenol A-bis(diphenyl phosphate) of the general formula (2):

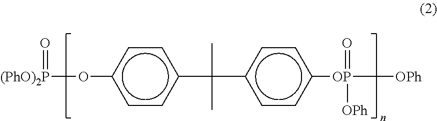

wherein n has an average value of from about 1 to about 2;

(c) a phosphonate ester of the formula (3):

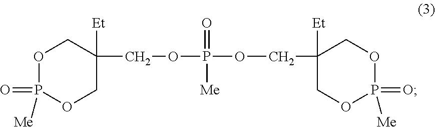 [SMILES: CCC1(COP(C)(=O)OCC2(CC)COP(C)(=O)OC2)COP(C)(=O)OC1]

(d) a phosphate ester of the general formula (4):

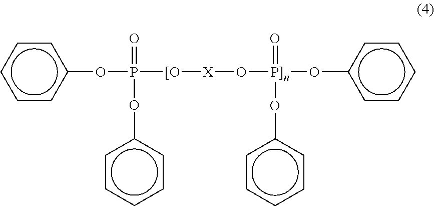

wherein n has an average value of from about 1.0 to about 2.0 and X is a divalent arylene moiety bonded to both of the oxygen atoms of any one of hydroquinone, resorcinol, 4,4′-biphenol, bisphenol S, or bisphenol F, and wherein the phosphate ester is in the absence of halogen;

(e) an aromatic phosphate of the formula (5):

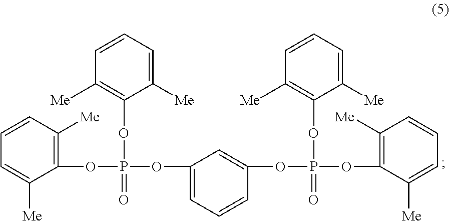 [SMILES: Cc1cccc(C)c1OP(=O)(Oc1cccc(OP(=O)(Oc2c(C)cccc2C)Oc2c(C)cccc2C)c1)Oc1c(C)cccc1C]

(f) a phosphate ester of the formula (6):

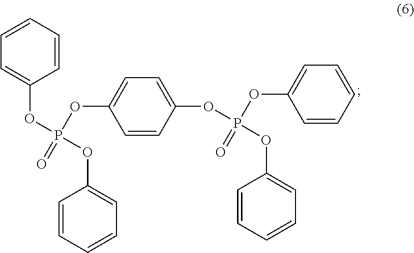 [SMILES: O=P(Oc1ccccc1)(Oc1ccccc1)Oc1ccc(OP(=O)(Oc2ccccc2)Oc2ccccc2)cc1]

(g) a phosphite ester of the general formula (7):

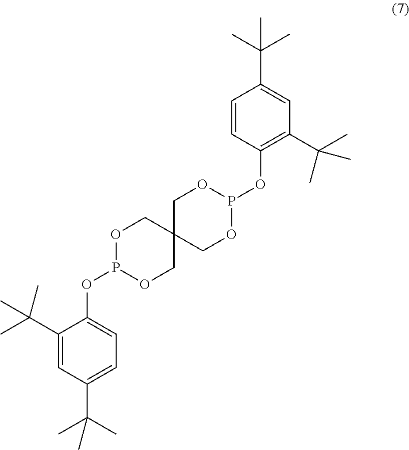

and

(h) mixtures thereof.

The phosphate ester of the general formula (4) is preferably hydroquinone bis(diphenyl phosphate) formula (6). The arylene X of the phosphate ester of the general formula (4) is preferably the divalent arylene moiety bonded to both of the oxygen atoms of hydroquinone. Preferably, the phosphate ester of the general formula (4) has a melting temperature of at least 80° C. This phosphate ester is disclosed in the PCT patent application WO 2010/104689.

Sometimes the flame retardant requires the addition of a flame retardant activator to help activate the flame retardant during the activation treatment. The flame retardant activator is preferably selected from the group consisting of: an additive capable of generating free radicals, a photoinitiator additive, thermal free radical initiator, a peroxide, an azo compound, and a metal catalyst.

The activation treatment is provided by exposure to radiation. The radiation is preferably selected from the group consisting of: ultraviolet, x-ray, gamma ray, visible, thermal, ionizing radiation, and electron beam.

The amount of flame retardancy improvement is determined by using the limiting oxygen index (LOI) test method ASTM D2863. According to the present invention, an improvement of at least about 1%, preferably at least about 2% and most preferably at least about 3% is expected.

The flame retardant article can be made into a fiber, a sheet or a film. These articles can be made by forming a masterbatch of from about 50 weight percent to less than about 100 weight percent polyolefin and up to about 15 weight percent of an activatable flame retardant with 0 weight percent to about 5 weight percent of a flame retardant activator and optional compatibilizer. The masterbatch can be melt spun or dissolved in a spinning solvent to produce flame retardant fibers and sheets. Additionally, the spinning components can be added separately to a melt extruder or a spinning solvent and spun into fibers avoiding the need to form a masterbatch. An example of a solvent spinning process is a flash-spinning process that produces plexifilamentary film-fibril strands which can be formed into sheets. Also, the spinning components can be compounded and directly cast into films. Alternatively, rather than be incorporated in the masterbatch or spinning solution, flame retardant activators can be applied using a solution dipping method directly to fibers, sheets and films. The flame retardant article of the present invention can be made into a building substrate, a garment, a banner, a light reflector and a cover.

### Test Methods

In the non-limiting examples that follow, the following test methods were employed to determine various reported characteristics and properties.

Limiting Oxygen Index (LOI) was performed according to the general procedure of ASTM D2863 and is designed to determine the minimum percent volume of oxygen needed to sustain flame combustion for a sample in a flowing oxygen and nitrogen environment. Thus, effective flame retardants would require higher oxygen levels than the atmospheric value of 21%, with the most effective additives having much higher LOI values. A Flame Testing Technology Limiting Oxygen Index (FTT LOI) apparatus was used to test a 5×13 cm vertically-supported test sample within a transparent glass chimney. The oxygen and nitrogen flowed upwards through this chimney. Using top surface ignition, the upper portion of the sample was ignited. The resulting burning behavior was observed. Burning of the entire length of sample is considered as a failure for the test. The test was repeated at increasing levels of oxygen percent volume, until the limiting oxygen index was obtained. Results were reported in oxygen volume % in the imposed atmosphere.

### EXAMPLES

The present invention will be described in more detail in the following examples.

Flame retardant plexifilamentary film-fibril strands were made using a flash spinning process with a 50 cc or a 1 gallon capacity flash spinning unit as described in U.S. Patent Publication 2013/0109791(A1). Activatable flame retardants and optional flame retardant activators and compatibilizers were either compounded with high density polyethylene (HDPE) and pelletized using standard procedures prior to introduction into the flash-spinning unit, or physically mixed with ground HDPE polymer and added directly to the flash-spinning unit. Subsequently, nonwoven handsheets were fabricated. The handsheets were then subjected to activation treatment. The flame retardant properties were measured on the handsheets before and after activation treatment.

HDPE was fed into a masterbatch extruder at a rate of 8.2 kg/hr (18 lb/hr). Liquid flame retardants were introduced into the masterbatch extruder with an injection pump (Isco Syringe Pump, Model 1000D, Isco, Lincoln, Nebr.) that had been heated to about 80° C. to facilitate pumping and subsequent mixing. Solid flame retardants were introduced into the masterbatch extruder with a K-Tron loss-in-weight feeder set to give the desired concentration. A high-mixing screw design was used with a temperature profile that varied from 240 (feed end) to 230° C. (die end) and a screw speed of 300 RPM. The polymer melt was extruded through a 6.35 mm (¼″) single-hole die, cooled in a water quench bath, and then pelletized. The blended pellets had a concentration from about 5 to about 10 wt. % flame retardant.

The blended pellets were introduced into either a 50 cc or a 1 gallon capacity flash-spinning unit.

The 50 cc capacity flash-spinning apparatus consists of two high-pressure cylindrical chambers, each equipped with a piston which is adapted to apply pressure to the contents of the chamber. The cylinders have an inside diameter of 2.54 cm and each has an internal capacity of 50 cc, hence the name. The cylinders are connected to each other at one end through a 0.23 cm diameter channel and a mixing chamber containing a series of fine mesh screens that act as a static mixer. Mixing is accomplished by forcing the contents of the vessel back and forth between the two cylinders through the static mixer. The pistons are driven by high-pressure water supplied by a hydraulic system. A spinneret assembly with a quick-acting means for opening the orifice is attached to the channel through a tee. The spinneret assembly consists of a lead hole of 0.63 cm diameter and about 5.08 cm length and a spinneret orifice with a length and a diameter each measuring 0.762 mm (30 mils). About 5 g HDPE/flame retardant/activator mixture was charged into one cylinder. The spin agent was a solution of reagent-grade pentane:cyclopentane (75:25) and was added by a high pressure pump to give 17% total polymer in the final solution. The polymer and spin agent were then heated to the mixing temperature of 185° C., as measured by a type J thermocouple and held at that temperature for 15 minutes, during which the pistons were used to alternately establish a differential pressure of about 2.1 MPa between the two cylinders. This action repeatedly forced the polymer and spin agent through the mixing channel from one cylinder to the other to provide mixing and to effect formation of a spin mixture. After mixing and just prior to spinning, the contents were placed completely in one cylinder by moving the other piston to the top of its cylinder. The pressure of the spin mixture was then reduced to the desired spinning pressure of 9.4 MPa. The spinneret orifice was then opened and the flash-spun product was spun into a nitrogen-purged enclosure to collect the HDPE plexifilamentary film-fibril strands.

The 1 gallon capacity flash-spinning apparatus employed herein was a larger version of the 50 cc unit. The apparatus consisted of two high-pressure cylindrical chambers, each equipped with a piston that had been adapted to apply pressure to the contents of the chamber through a hydraulic pump. The cylinders each had an internal capacity of 1 gallon. The cylinders were connected to each other at one end by a channel with a static mixer. Mixing was accomplished by forcing the contents of the vessel back and forth between the two cylinders through the static mixer. The pistons were driven by high-pressure oil supplied by a hydraulic system. The output of one of the cylinders was attached to a chamber that had a spinneret assembly at the other end. The spinneret orifice measured 0.762 mm. About 250 g HDPE/flame retardant/activator mixture was charged into one cylinder. The spin agent was a solution of reagent-grade pentane:cyclopentane (75:25) and was added by a high pressure pump to give 17% total polymer in the final solution. The polymer and spin agent were then heated to the mixing temperature of 185° C., as measured by a type J thermocouple and held at that temperature for 1 hour during which the pistons were used to alternately establish a differential pressure of about 2.1 MPa between the two cylinders. This action repeatedly forced the polymer and spin agent through the mixing channel from one cylinder to the other to provide mixing and to effect formation of a spin mixture. After mixing and just prior to spinning, the contents were placed completely in one cylinder by moving the other piston tot the top of its cylinder. The pressure of the spin mixture was then reduced to the desired spinning pressure of 7.9 MPa. The spinneret orifice was then opened and the flash-spun product was redirected by a baffle onto a moving Reemay®-covered belt in a nitrogen-purged stainless steel enclosure to collect the HDPE plexifilamentary film-fibril strands.

Handsheets were made from the HDPE plexifilamentary film-fibril strands by taking approximately 2.8 g of the spin material and placing it on a Mylar® film with an approximate area of 10×26 mm. Another piece of Mylar® film was placed on top, and the assemblage was compressed into a consolidated layer of fibers. The Mylar® films were then removed, and the consolidated layer of fibers was placed in a manila folder and passed through a GPC HeatSeal® H700 ProLaminator set at 120° C. and a speed of three. The inner sections were cut out to give pieces that were 9 cm×25 cm. The basis weights of the final handsheets were about 80 g/m².

In another embodiment of the invention, the flame retardants with HDPE were compounded and directly cast into films instead of being spun into fiber and then pressed into handsheets. HDPE and compounded masterbatches with 10% of each ingredient were mixed in a polyethylene bag to give 2 lbs of a final composition of 7%. This blend was fed to the throat of a Werner & Pfleiderer 28 mm twin screw extruder. Barrel zone temperatures ranged from 230° C. at the first zone to 240° C. at the die with a screw speed of 150 rpm. Molten polymer was delivered to a film die, 254 mm wide×4 mm height, to produce a 4 mm thick 254 mm wide film. The film was placed on a rotating smooth casting drum to cool the film. The speed was adjusted to give a film basis weight of about 50 gsm.

Films and nonwoven handsheets were inserted into a metal sample holder and placed inside a Q-Labs QUV weatherometer. The samples were exposed to an activation treatment of UV irradiation from UVA-340 bulbs with peak irradiance near 340 nm and a spectral distribution ranging from about 290 nm to over 400 nm in order to carry out the activation. The QUV weatherometer power level was set to 0.83 W/m² and the temperature control was set to 50° C. The duration of exposure of the samples was 336 continuous hours, resulting in a total energy exposure (over the entire UV and visible spectrum) of 56 MJ/m².

### Comparative Example A

Comparative Example A represents a nonwoven handsheet made without any flame retardant. High density polyethylene (HDPE) plexifilamentary film-fibril strands were made using the process described above with a 1 gallon flash-spinning unit. Plexifilamentary film-fibril strands were collected and nonwoven handsheets were made therefrom. Limiting oxygen index testing before and after activation treatment can be found in the Table.

Comparative Example A demonstrates the flame retardancy of the nonwoven handsheet without any flame retardant.

### Examples 1 and 2

Examples 1 and 2 demonstrate nonwoven handsheets of the present invention. Examples 1 and 2 were prepared in a similar manner to Comparative Example A except flame retardants were added. Liquid flame retardants (3) Amgard® 1045 available from Rhodia, Cranbury, N.J. and flame retardant (2) Fyrolflex® BDP available from ICL-Industrial Products, Beersheva, Israel, respectively, were introduced into the masterbatch extruder as described above. The blended pellets had a concentration of 5 and 10 wt. % flame retardant for Examples 1 and 2, respectively. HDPE plexifilamentary film-fibril strands were made and nonwoven handsheets were made therefrom. Limiting oxygen index testing before and after activation treatment can be found in the Table.

Examples 1 and 2 demonstrate nonwoven handsheets with improved flame retardancy after activation treatment.

### Example 3

Example 3 demonstrates a nonwoven handsheet of the present invention incorporating a compatibilizer. Some flame retardants do not blend well with the base polymer in the masterbatch extruder. This problem can be overcome by using a compatibilizer. Example 3 was prepared in a similar manner to Example 1 except using a different flame retardant and adding a compatibilizer. Example 3 was made using flame retardant (5) PX-200 available from Daihachi Chemicals, Japan in place of (3) Amgard® 1045. Fusabond® E100 ethylene maleic anhydride, a compatibilizer, available from DuPont Company, Wilmington, Del. was fed into the masterbatch extruder to improve blending of the flame retardant with the base polymer and to give a 5 wt. % concentration. Limiting oxygen index testing before and after activation treatment can be found in the Table.

Example 3 demonstrates a nonwoven handsheet with a compatibilizer to improve blending of the flame retardant with the base polymer provides improved flame retardancy after activation treatment.

### Example 4

Example 4 demonstrates a nonwoven handsheet of the present invention using direct addition of flame retardant into the flash-spinning apparatus. Example 4 was prepared in a similar manner to Example 2 except using a different flame retardant and utilizing the direct addition of flame retardant. Flame retardant (7) Ultranox 626 available from Chemtura, Philadelphia, Pa. was used in place of (2) Fyrolflex® BDP. Instead of adding the flame retardant to the masterbatch extruder, the flame retardant was added directly to the flash spinning apparatus to give a 10 wt % concentration. Limiting oxygen index testing before and after activation treatment can be found in the Table.

Example 4 demonstrates a nonwoven handsheet utilizing direct addition of the flame retardant into the flash-spinning apparatus provides improved flame retardancy after activation treatment.

### Comparative Example B and Examples 5 and 6

Examples 5 and 6 demonstrate a nonwoven handsheet of the present invention using a flame retardant activator. In addition to activation treatment, the flame retardant can be activated with a flame retardant activator. Comparative Example B was prepared in a similar manner to Example 4 except a different flame retardant was used. Examples 5 and 6 were prepared in a similar manner to Example 4 except using a different flame retardant, adding a flame retardant activator and flash spinning using a 50 cc flash-spinning unit. Flame retardant (3) Amgard® 1045 available from Rhodia, Cranbury, N.J. was used in place of (2) Fyrolflex® BDP. Flame retardant activators benzophenone, Example 5, and 2,2-dimethoxy-2-phenylacetophenone (DMPA), Example 6, were added directly to the flash spinning apparatus to give a 1 wt % concentration. Limiting oxygen index testing before and after activation treatment can be found in the Table.

Comparative Example B is comparable to Example 1 except with direct addition of flame retardant (3) Amgard® 1045 in place of masterbatch compounded flame retardant (3) Amgard® 1045. The direct addition of flame retardant (3) Amgard® 1045 in Comparative Example B did not show any improvement in flame retardancy after activation treatment. Interestingly, Example 1 did show improvement in flame retardancy as compared to Comparative Example B. This could be due to the additional heat history of Example 1 that was incurred during masterbatch compounding. However, Examples 5 and 6 demonstrated that after incorporating a flame retardant activator, flame retardancy is improved after activation treatment.

### Examples 7 and 8

Examples 7 and 8 demonstrate films of the present invention. Examples 7 and 8 were prepared in a similar manner to Example 1 except using different flame retardants and preparing a film in place of a nonwoven handsheet. Flame retardant (2) Fyrolflex® BDP and (1) Fyrolflex® RDP both available from ICL-Industrial Products, Beersheva, Israel were used in place of (7) Ultranox 626. Films were prepared as described above. These examples demonstrate making a flame retardant article using a polymer melt process as opposed to the other examples which used a flash spinning process. Limiting oxygen index testing before and after activation treatment can be found in the Table.

Examples 7 and 8 demonstrate films with improved flame retardancy after activation treatment.

TABLE
Example Preparation and Flame Retardant Properties

| | | | | | | | | | LOI | |
|---|---|---|---|---|---|---|---|---|---|---|
| | | | | | Flame | | | | Before | LOI After |
| | Flame | | | | Retardant | Flame | | | Activation | Activation |
| | Retardant | Flame | Flame Retardant | Compatibilizer | Activator | Retardant | Method of | | Treatment | Treatment |
| Example | (wt %) | Retardant | Type | (wt %) | (wt %) | Activator | Incorporation | Article | (%) | (%) |
| A | | | | | | | | nonwoven | 21.9 | 20.6 |
| 1 | 5 | Amgard ® | phosphonate | | | | compounded | nonwoven | 22.2 | 28.2 |
| | | 1045 | | | | | | | | |
| 2 | 10 | BDP | phosphate | | | | compounded | nonwoven | 24.7 | 27.2 |
| 3 | 5 | PX-200 | phosphate | 5 | | | compounded | nonwoven | 21.1 | 23.0 |
| 4 | 10 | Ultranox | phosphite | | | | direct | nonwoven | 21.0 | 22.0 |
| | | 626 | | | | | addition | | | |
| B | 10 | Amgard ® | phosphonate | | | | direct | nonwoven | 24.0 | 23.5 |
| | | 1045 | | | | | addition | | | |
| 5 | 10 | Amgard ® | phosphonate | | 1 | benzo- | direct | nonwoven | 24.0 | 27.5 |
| | | 1045 | | | | phenone | addition | | | |
| 6 | 10 | Amgard ® | phosphonate | | 1 | DMPA | direct | nonwoven | 24.5 | 27.0 |
| | | 1045 | | | | | addition | | | |
| 7 | 7 | BDP | phosphate | | | | compounded | film | 23.6 | 24.9 |
| 8 | 7 | RDP | phosphate | | | | compounded | film | 24.6 | 26.7 |

What is claimed is:

1. A flame retardant article comprising:
(a) from about 50 weight percent to less than about 100 weight percent of a polyolefin;
(b) up to about 15 weight percent of an activatable flame retardant; and
(c) from 0 weight percent to about 5 weight percent of a flame retardant activator; and
wherein the flame retardant performance of the flame retardant article is at least about 1% higher on the limiting oxygen index (LOI) scale after activation treatment than before activation treatment as measured by LOI ASTM D2863.

2. The flame retardant article of claim 1, wherein the polyolefin is selected from the group consisting of polyethylene, polypropylene and their copolymers.

3. The flame retardant article of claim 1, wherein the activatable flame retardant contains phosphorous.

4. The flame retardant article of claim 3, wherein the phosphorus containing activatable flame retardant is selected from the group consisting of: phosphate esters, phosphonate esters, phosphite esters, and mixtures thereof.

5. The flame retardant article of claim 4, wherein the phosphorus containing activatable flame retardant is selected from the group consisting of:
(a) a resorcinol bis(diphenyl phosphate) of the general formula (1): 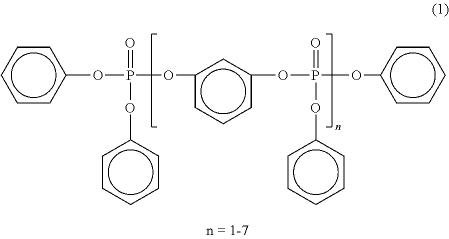
wherein n has an average value of from about 1 to about 7;
(b) a bis-phenol A-bis(diphenyl phosphate) of the general formula (2): 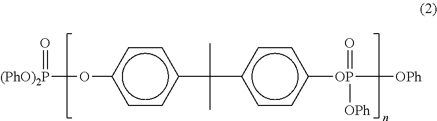
wherein n has an average value of from about 1 to about 2;
(c) a phosphonate ester of the formula (3): 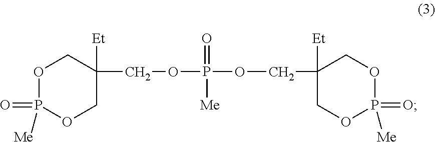 [SMILES: CCC1(COP(C)(=O)OCC2(CC)COP(C)(=O)OC2)COP(C)(=O)OC1]
(d) a phosphate ester of the general formula (4): 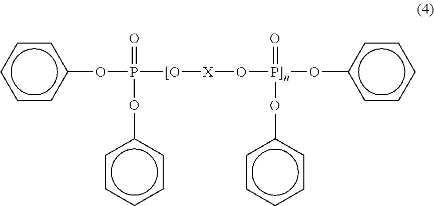
wherein n has an average value of from about 1.0 to about 2.0 and X is a divalent arylene moiety bonded to both of the oxygen atoms of any one of hydroquinone, resorcinol, 4,4′-biphenol, bisphenol S, or bisphenol F, and wherein the phosphate ester is in the absence of halogen;
(e) an aromatic phosphate of the formula (5): 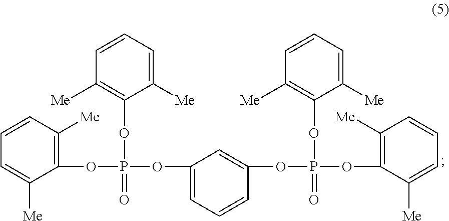 [SMILES: Cc1cccc(C)c1OP(=O)(Oc1cccc(OP(=O)(Oc2c(C)cccc2C)Oc2c(C)cccc2C)c1)Oc1c(C)cccc1C]
(f) a phosphate ester of the formula (6): 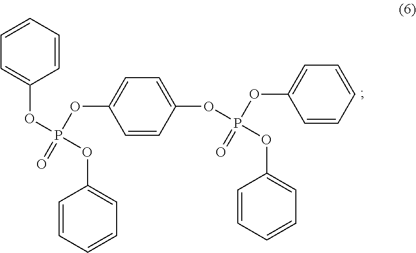 [SMILES: O=P(Oc1ccccc1)(Oc1ccccc1)Oc1ccc(OP(=O)(Oc2ccccc2)Oc2ccccc2)cc1]
(g) a phosphite ester of the general formula (7): 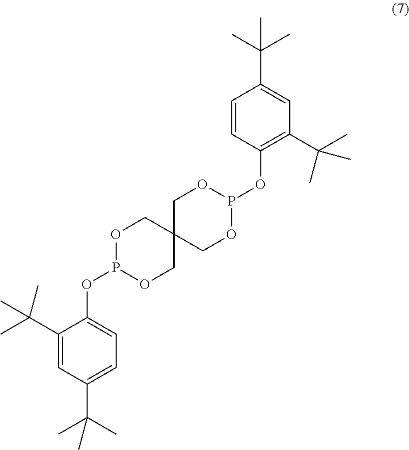
and
(h) mixtures thereof.

6. The flame retardant article of claim 5, wherein the phosphate ester of the general formula (4) is hydroquinone bis(diphenyl phosphate).

7. The flame retardant article of claim 5, wherein the arylene X of the phosphate ester of the general formula (4) is the divalent arylene moiety bonded to both of the oxygen atoms of hydroquinone.

8. The flame retardant article of claim 5, wherein the phosphate ester of the general formula (4) has a melting temperature of at least 80° C.

9. The flame retardant article of claim 1, wherein the flame retardant activator is selected from the group consisting of: an additive capable of generating free radicals, a photoinitiator additive, thermal free radical initiator, a peroxide, an azo compound, and a metal catalyst.

10. The flame retardant article of claim 1, wherein the activation treatment comprises exposure to radiation.

11. The flame retardant article of claim 10, wherein the radiation is selected from the group consisting of: ultraviolet, x-ray, gamma ray, visible, thermal, ionizing radiation, and electron beam.

12. The flame retardant article of claim 1, wherein the flame retardant article is a fiber, a sheet or a film.

13. The flame retardant article of claim 12, wherein the sheet is selected from the group consisting of: a building substrate, a garment, a banner, a light reflector and a cover.

14. The flame retardant article of claim 12, wherein the sheet comprises a plexifilamentary film-fibril strand.
